(19) United States
(12) Patent Application Publication
(10) Pub. No.: US 2008/0099523 A1
(43) Pub. Date: May 1, 2008

(54) Structure For Housing Case With Stepometer

(76) Inventor: Eagle Fan, Chu-Pei City (TW)

Correspondence Address: LIN & ASSOCIATES INTELLECTUAL PROPERTY, INC., P.O. BOX 2339, SARATOGA, CA, 95070-0339, US

(21) Appl. No.: 11/554,592

(22) Filed: Oct. 31, 2006

(51) Int. Cl. G01C 21/00; G01C 22/00; A45C 1/04; A45F 3/00

(52) U.S. Cl. 224/666; 224/930; 377/24.2; 702/160

(57) ABSTRACT

A structure for a housing case with a stepometer is provided, including a housing case and a stepometer integrated on the housing case. The housing case includes a housing space for housing an item, such as mobile phone, MP3 player, glasses, that the user will constantly retrieve. The housing case includes a foldable upper cover. When folded, the upper cover closed the housing space. The stepometer is located on the upper cover. The housing case also includes a connection element on the back so that the user can fasten the housing case on the waist. The present invention provides the user with a housing case for housing a portable item as well as a stepometer to keep track of own walking activity.

### FIELD OF THE INVENTION

The present invention generally relates to a structure for a housing case, and more specifically to a housing case used around the waist, and with a stepometer.

### BACKGROUND OF THE INVENTION

The advancement of technology provides comfortable working environment as well as convenient transportation vehicles for people to move around. The accompanied shortcoming for the ubiquitous convenience is that lack of exercise that most people are experiencing. The medical study shows that a person must take 30 minutes of high-activity exercise everyday to stay fit. An alternative is to walk about 10,000 steps to keep the metabolism and blood circulation to boost the immunity. However, such a healthy routine is not always easy for most people, especially when a person is busy with daily work routine. It is quite common for a person to forget the walk-10,000-step goal. It would be of interest to most people if there exists a simple reminder mechanism that would remind the person to keep track of the steps to walk. A stepometer provides such a reminder mechanism.

Another common phenomenon is that most people carry mobile phones. Many people, especially male, wear a housing case around the waist to carry the mobile phone as for easy retrieval. This coincides with the fact that the people that need the exercise most are also male, especially for office workers. It is therefore imperative to integrate the stepometer with a common daily used item as a convenient reminder to remind the user to keep track of his or her steps.

### SUMMARY OF THE INVENTION

The primary object of the present invention is to provide a structure for a housing case with a stepometer. The structure for housing case includes a housing case that can be worn around the waist of a user. The housing case includes a housing space for housing common items, such as mobile phone or reading glasses, sun glasses, and so on. The stepometer on the housing case can keep track of the number of the steps that the user has walked so that the user can be constantly reminded of the importance of exercise.

Another object of the present invention is to provide a constant reminder and an inspiring apparatus of a housing case with a stepometer. The medical study shows that the user with the stepometer placed inside a pocket or an non-obvious place is less likely to keep track of own activity. On the other hand, the user with the stepometer placed at a visible place can be constantly reminded of to walk and keeping track of own activity. The housing case of the present invention is to house an item that the user can constantly access. Therefore, when the user access the item placed inside the housing case, the user can be reminded, and inspired to walk more steps.

To achieve the above objects, the present invention is to provide a structure for a housing case with a stepometer, including a housing case and a stepometer integrated on the housing case. The housing case includes a housing space for housing an item that the user will constantly retrieve. The housing case includes a foldable upper cover. When folded, the upper cover closed the housing space. The stepometer is located on the upper cover. The housing case also includes a connection element on the back so that the user can fasten the housing case on the waist. The present invention provides the user with a housing case for housing a portable item as well as a stepometer to keep track of own walking activity.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a three-dimensional view of the present invention;

FIG. 2 shows a cross-sectional view of the present invention;

FIG. 3 shows another three-dimensional view from a different angle;

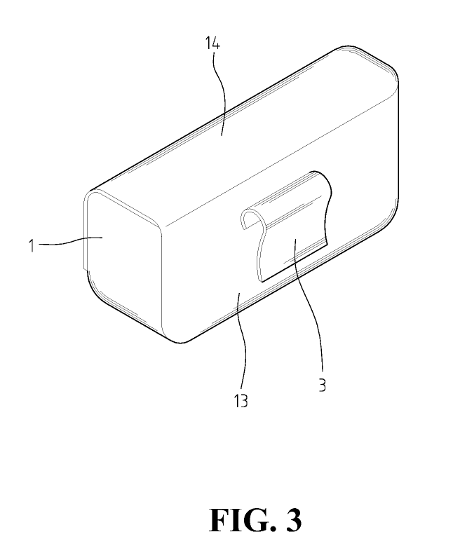

FIG. 4 shows a schematic view of the present invention in actual use; and

FIG. 5 shows a second embodiment of the present invention.

### DETAILED DESCRIPTION OF THE PREFERRED EMBODIMENTS

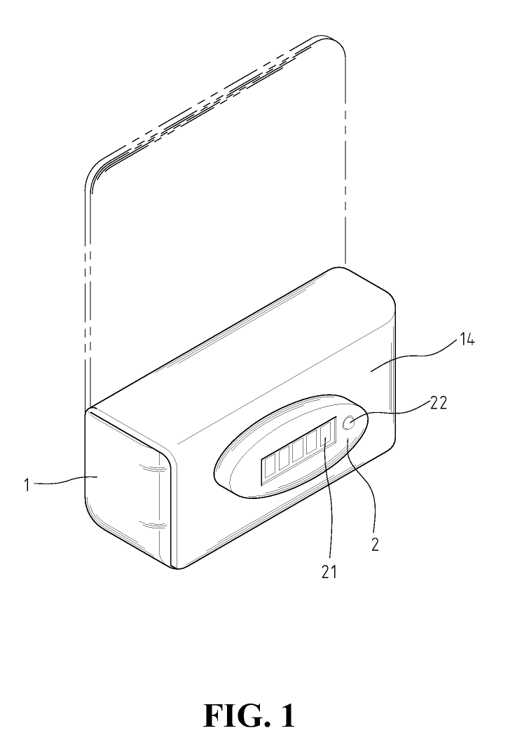

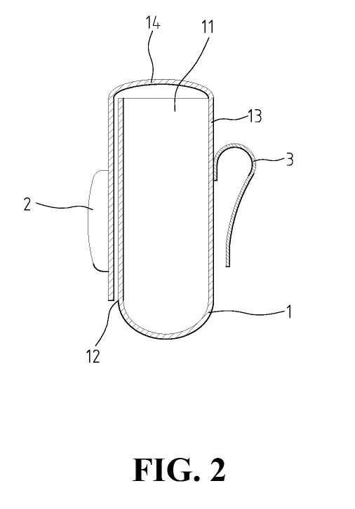

FIGS. 1 and 2 show a three-dimensional view and a cross-sectional view of the present invention, respectively. The present invention includes a housing case 1, and a stepometer 2 integrated to the housing case. Housing case 1 includes a housing space 11 for housing portable items. Housing space 11 is not limited to any specific shape. The shape and the size of housing space 11 depends on the items it houses. The housed item can be an electronic device, such as mobile phone or MP3 player, or other daily items, such as reading glasses or sunglasses. Housing case 1 includes a foldable upper cover 14. The dash line of FIG. 1 shows the folded line unfolded. When folded, upper cover 14 can be partially attached to a first side 12 of housing case 1 to seal housing space 11 for prevent dust or the housed item from falling off. Stepometer 2 is located on upper cover 14 of housing case 1, at the location of the front surface so that the user can easily check the step reading when opening upper cover 14. Stepometer 2 includes a display 21 and a touch switch 22. Touch switch 22 can also be designed as a reset button, and will shut off the power when pressed for a period, for example, 5 seconds. A light touch to touch switch 22 will reset display 21 to zero. For the convenience of fastening to the waist, as shown in FIGS. 2 & 3, the back of housing case 1 includes a connecting element 3. Connecting element 3 is on a second side 13, which is opposite to first side 12. In the present embodiment, connecting element 3 is a resilient clipper with a large curvature so that it can clip to the waist belt or the top of the pants. In this way, housing case 1 can be easily fastened to the user's waist.

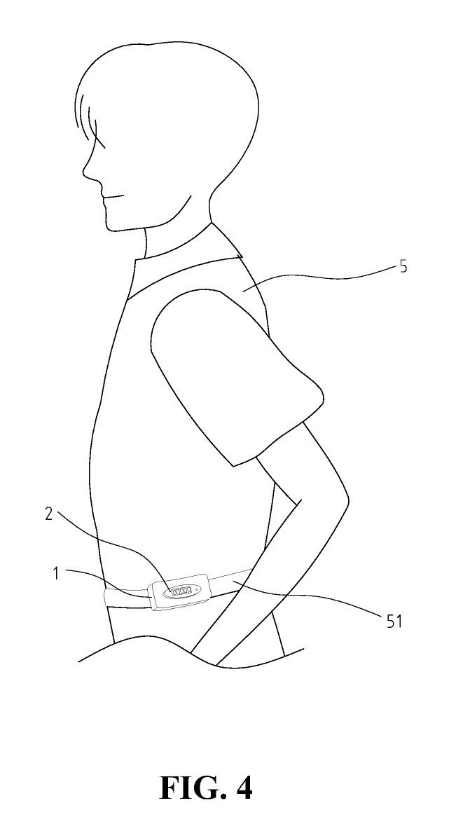

FIG. 4 shows a schematic view of the present invention in actual use. The connecting element allows a user 5 to fasten housing case 1 to a belt 51 around the waist so that user 5 can easily carry around. The housed item, such as mobile phone, can be placed inside housing space 11 of housing case 1. In the movement during the work, stepometer 2 can keep track of the steps user 5 has walked and user 5 can check the step reading on stepometer 2 when retrieving the item from housing case 1. Therefore, user 5 can be reminded to take more steps if the reading is far below the target 10,000 steps.

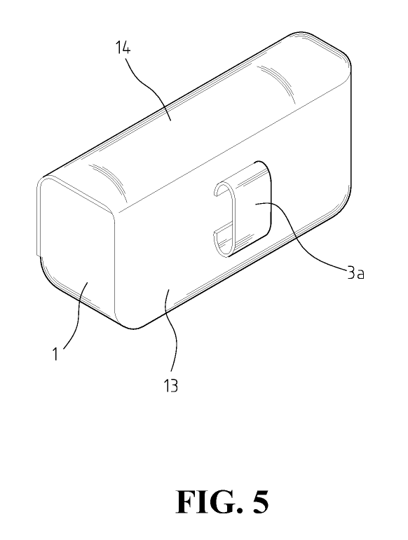

FIG. 5 shows a second embodiment of the present invention. In this embodiment, the connecting element 3a is a band-shape element. The two ends of the band are engaged to the upper and lower position of second side 13 of housing case 1. A gap exists between connecting element 3a and second side 13 of housing case 1. The gap is for the belt to pass through so that the housing case can be fastened to the user's belt. This embodiment shows that the connecting element is not limited to any specific type. Any structure that can be used to clip or fasten to the user's waist can be used as the connecting element of the present invention.

In summary, the structure for a housing case with stepometer provides a housing case for housing an item that can be easily retrieved, and when the user retrieves the item, the stepometer can keep track of and remind the user of the target steps the user should walk.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A structure for housing case with a stepometer, comprising:
a housing case, said housing case comprising a housing space for housing items, the back of said housing case having a connecting element for fastening to a user's waist, said housing case further comprising a foldable upper cover for covering said housing space when folded; and
a stepometer, located on and integrated to said housing case.

2. The structure as claimed in claim 1, wherein said stepometer is located on said upper cover of said housing case.

3. The structure as claimed in claim 2, wherein said stepometer is located on the front surface of said upper cover.

4. The structure as claimed in claim 1, wherein said connecting element is a resilient clip.

5. The structure as claimed in claim 1, wherein said connecting element is a band having two ends engaged to said housing case, and there exists a gap between said band and said housing case.
